(19) United States
(12) Patent Application Publication
(10) Pub. No.: US 2016/0353128 A1
(43) Pub. Date: Dec. 1, 2016

(54) DECODING OF INTRA-PREDICTED IMAGES

(71) Applicant: Microsoft Technology Licensing, LLC, Redmond, WA (US)

(72) Inventors: Matthew Wozniak, Redmond, WA (US); Yongjun Wu, Bellevue, WA (US); Shyam Sadhwani, Bellevue, WA (US)

(21) Appl. No.: 14/727,805

(22) Filed: Jun. 1, 2015

(51) Int. Cl. H04N 19/593; H04N 19/182; H04N 19/192; H04N 19/176

(52) U.S. Cl. CPC H04N 19/593; H04N 19/176; H04N 19/182; H04N 19/192

(57) ABSTRACT

In a computer with a graphics processing unit as a coprocessor of a central processing unit, the graphics processing unit is programmed to perform waves of parallel operations to decode intra-prediction blocks of an image encoded in a certain video coding format. To decode the intra-prediction blocks of an image using the graphics processing unit, the intra-predicted blocks and their reference blocks are identified. The computer identifies whether pixel data from the reference blocks for these intra-predicted blocks are available. Blocks for which pixel data from reference blocks are available are processed in waves of parallel operations on the graphics processing unit as the pixel data becomes available. The process repeats until all intra-predicted blocks are processed. The identification of blocks to process in each wave can be determined by the graphics processing unit or the central processing unit.

### BACKGROUND

Digital media data, such as audio and video and still images, are commonly encoded into bitstreams that are transmitted or stored in data files, where the encoded bitstreams conform to established standards. An example of such a standard is a format called ISO/IEC 23008-2 MPEG-H Part 2, also called and ITU-T H.265, or HEVC or H.265. Herein, a bitstream that is encoded in accordance with this standard is called an HEVC-compliant bitstream.

As part of the process of encoding video, such as to produce an HEVC-compliant bitstream, a technique called intra-prediction can be used to reduce redundancy of information within an image, also called a frame. In general, an image is divided into blocks, and each pixel in each block is compared to one or more reference blocks for that block within the image to compute a prediction value for that pixel. An image may also be divided into groups of blocks, which may be called slices or tiles. Such groupings can limit intra-prediction to be performed within the groups. In HEVC/H.265, the blocks that are compared are called prediction units and may be as small as four pixels by four pixels.

The decoding process for intra-prediction blocks of an image is highly serial and difficult to parallelize, because decoding of an intra-prediction block depends on the decoder first computing pixel data for the reference blocks on which the intra-prediction is based. Such serial dependencies arise with several different video coding formats, such as the HEVC/H.265 and VP9 video coding formats.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In a computer with a graphics processing unit as a coprocessor of a central processing unit, the graphics processing unit is programmed to perform waves of parallel operations to decode intra-prediction blocks of an image. To decode the intra-prediction blocks of an image using the graphics processing unit, the intra-predicted blocks and their reference blocks are identified. The computer identifies whether pixel data from the reference blocks for these intra-predicted blocks are available. Blocks, for which pixel data from reference blocks are available, are processed in waves of parallel operations on the graphics processing unit as the pixel data becomes available. The process repeats until all intra-predicted blocks are processed. The identification of blocks to process in each wave can be determined by the graphics processing unit or the central processing unit. A coprocessor other than a graphics processing unit also can be used.

The computer can compute and use an availability map and to track information about reference blocks for which pixel data is available. The computer can use a queue to track information about which blocks are part of a next wave of processing. The availability map is updated for each wave.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example operating environment for playback of media data that has been encoded using intra-prediction.

FIG. 2 is a block diagram of an example implementation of an intra-prediction module for a video decoder.

FIG. 3 is an illustrative example of an availability map, input queue and next wave queue in different stages of processing.

FIG. 4 is a flow chart of an example implementation of a first phase of an initialization process for an availability map.

FIG. 5 is a flow chart of an example implementation of a second phase of an initialization process for an availability map.

FIG. 6 is a flow chart of an example implementation of wave processing.

FIG. 7 is a block diagram of an example computing device with which components of such a system can be implemented.

### DETAILED DESCRIPTION

The following section provides an example operating environment for playback of media data that has been encoded using intra-prediction.

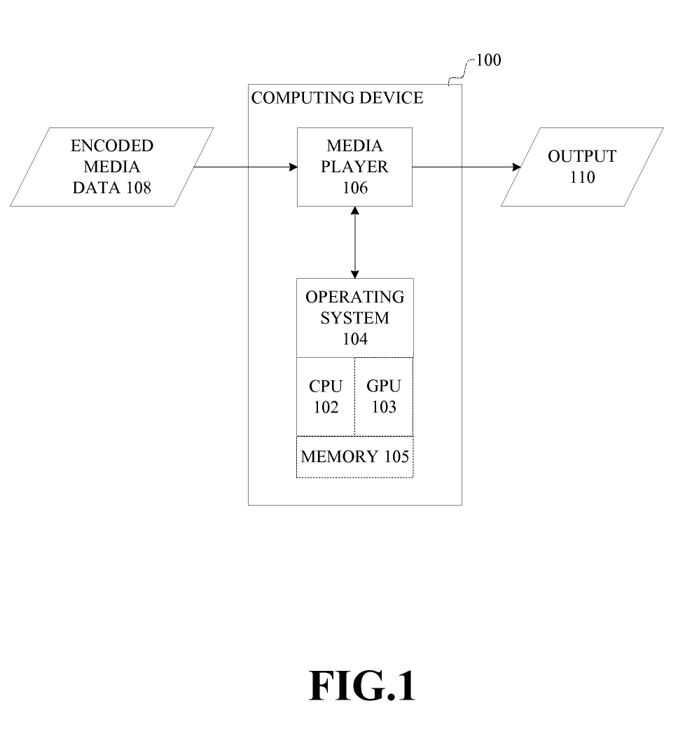

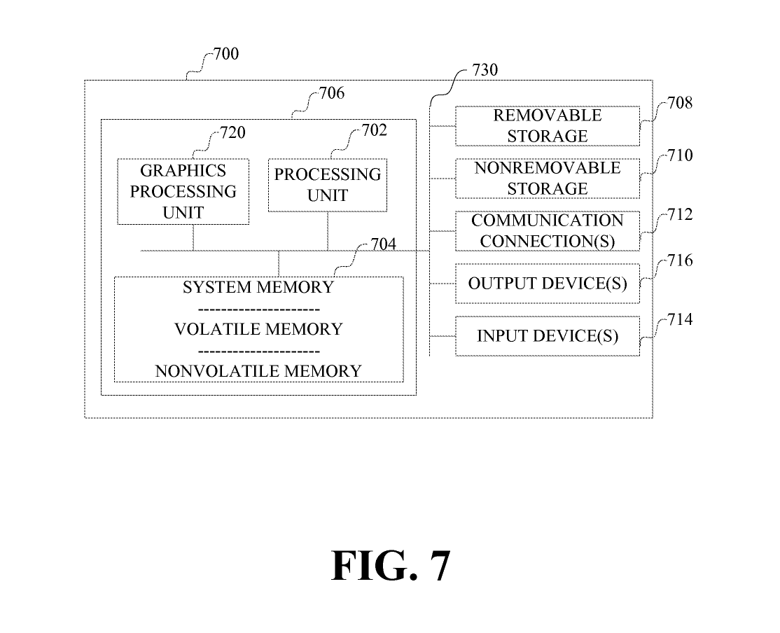

Referring to FIG. 1, an example media processing system includes a computing device 100, which includes a central processing unit 102, graphics processing unit 103, an operating system 104 and a media processor 106. In this example, the media processor can be an application that runs on the operating system of the device, and the operating system manages access to the resources of the computing device, such as the central processing unit 102, graphics processing unit 103, memory 105 and other components of the computing device. An example computer is described below in connection with FIG. 7. (Herein, the terms graphics processing unit, graphics coprocessor and GPU are intended to be synonymous). A coprocessor other than a graphics processing unit, such as a digital signal processor, programmable gate array, dedicated processing logic device, etc., can be used.

The media processor 106 can implement, for example, a video decoder that reads media data 108 which has been encoded into a bitstream that is compliant with a standard data form that the decoder is implemented to handle. For example, the media processor can be an HEVC-compliant video decoder.

An encoded bitstream generally represents encoded digital media data, such as audio, video, still images, text and auxiliary information. If there are multiple media streams, such as audio and video, the streams of encoded data can be multiplexed into a single bitstream. Encoded bitstreams generally either are transmitted, in which case the may be referred to as streamed data, or are stored in data files. Encoded bitstreams, and files they are stored in, generally conform to established standards. Many such standards specify structures of data, typically called packets but which may be called other names, which include metadata, providing data about the packet, and/or encoded media data, sometimes called essence data, and/or auxiliary information that is associated with the encoded media data, such as parameters for operations used to decode an image from a packet or set of packets. The specification of the standard defines which structures are required, which structures are optional, and what various structures, fields and field values mean.

A video decoder implemented by the media processor 106 can be part of any application that reads and decodes the media data from the encoded bitstream to produce an output 110. The media processor 106 can be used by other applications (not shown) to provide media playback for that application.

A video decoder can be implemented so as to take advantage of parallelization and/or fast matrix, vector and other processing available through a graphics processing unit or other coprocessor. For example, a graphics processing unit can process blocks of image data in parallel for improved performance.

An application can utilize and application programming interface (API) to a graphics library, where a video decoder is implemented, in some cases as a “shader”, within the graphics library. The API manages access by an application to the central processor, graphics processing unit or other coprocessor and memory resources of the computing device. Examples of commercially available API layers are the OpenGL interface from Khronos Group and the Direct3D interface from Microsoft Corporation. An application can also utilize the graphics processing unit without using such an API.

To decode encoded video using a computing device 100 with a central processing unit 102 and a graphics processing unit (GPU) 103 as a coprocessor, blocks of image data are stored in memory. Decoding parameters to be applied to the blocks of image data, and the locations of those blocks in memory, are transferred from the central processing unit to the graphics processing unit.

To decode media data 108 that includes encoded video data, a video decoder reads the bitstream and applies various operations to the encoded data according to parameters that also may be stored in the bitstream. When decoding an image from a bitstream that includes images encoded using intra-prediction, such as an HEVC-compliant bitstream, the encoded bitstream indicates, for a given image or frame, which blocks of the frame are encoded using intra-prediction. The following description is an example implementation for decoding the blocks of the frame that are encoded using intra-prediction.

Generally speaking, in a computer with a graphics processing unit as a coprocessor of a central processing unit, a video decoder can be implemented by instructing the graphics processing unit to perform waves of parallel operations to decode intra-prediction blocks of an image. To decode the intra-prediction blocks of an image using the graphics processing unit, the intra-predicted blocks and their reference blocks are identified. Whether pixel data from the reference blocks for these intra-predicted blocks are available is also determined Blocks for which pixel data from reference blocks are available are processed in waves of parallel operations on the graphics processing unit as the pixel data becomes available. The process repeats until all intra-predicted blocks are processed. The identification of blocks to process in each wave can be determined by the graphics processing unit or the central processing unit.

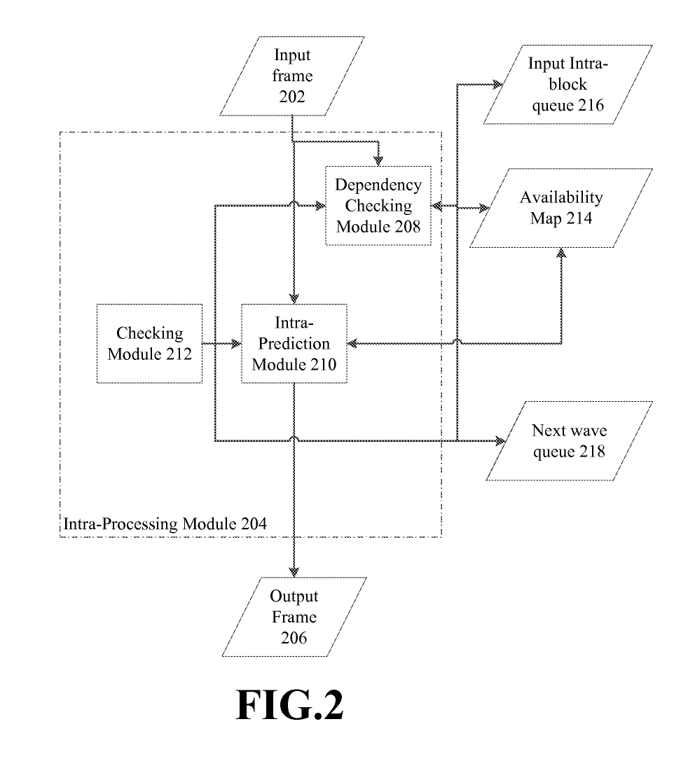

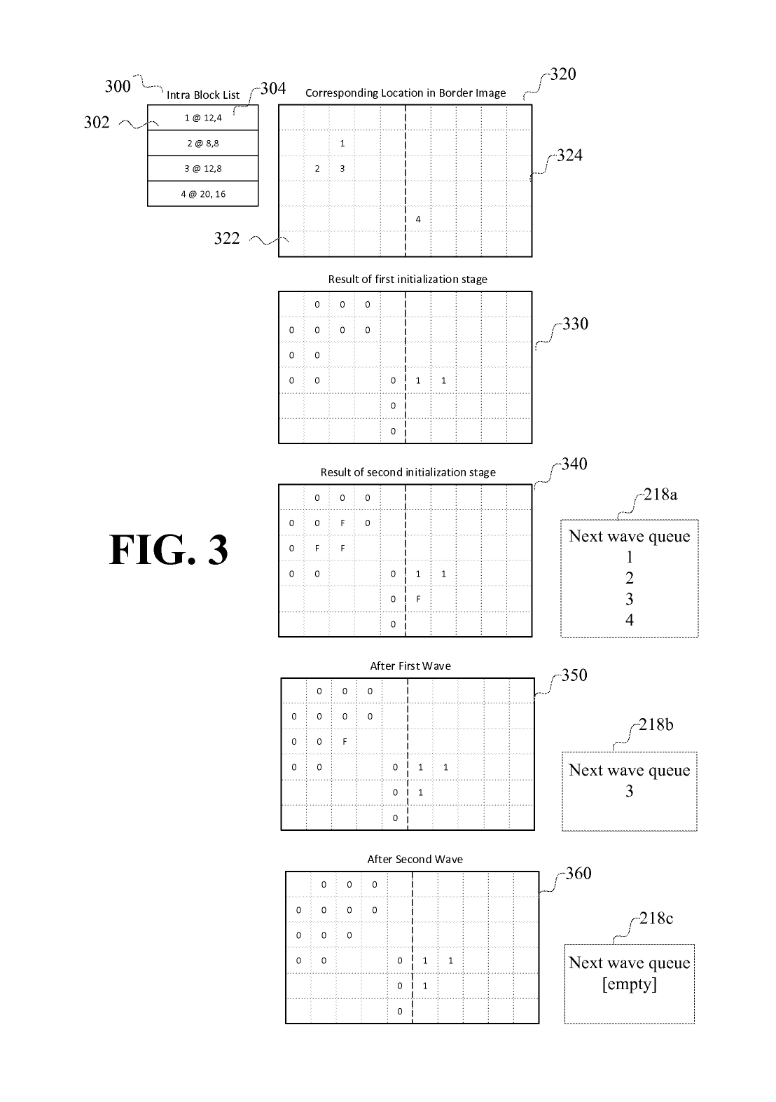

Referring now to FIGS. 2 and 3, a block diagram of an example implementation of a video decoder 200 will now be described. In FIG. 2, an input frame 202 is processed by an intra-processing decoding module 204 to produce an output frame 206.

The intra-processing decoding module includes a dependency checking module 208 which identifies, for each block, any other block on which it depends. As described in more detail below, the dependency checking module 208 can be implemented using an application executed on the central processing unit of the computer, or can be implemented using one or more shaders executed on the graphics processing unit of the computer.

An intra-prediction module 210 performs the computations on the intra-prediction data for specified blocks of the input frame 202. To take advantage of the parallelism of the graphics processing unit, the intra-prediction module 210 can be implemented as a shader to be executed on the graphics processing unit. Multiple such shaders can be dispatched during each wave of processing to allow multiple blocks to be processed in parallel.

Whether the intra-prediction computations are complete for a frame is determined by a checking module 212, by tracking which intra-predicted blocks have been processed. The checking module initiates each wave of processing until all the intra-predicted blocks have been processed. The checking module can be implemented using an application executed on the central processing unit.

In this example implementation, the dependency checking module 208 can use an availability map 214 to track information about reference blocks for which pixel data is available. The dependency checking module 208 and intra-prediction module 210 also access an input intra-block queue 216 and one or more next wave queues 218 to track information about which blocks are part of any next wave of processing, with a queue 218 for each wave of processing. The dependency checking module updates the availability map 214 and generates a next wave queue 218 in each wave of processing. The checking module 212 determines whether to initiate a new wave or if intra-processing of the frame is complete, for example by examining the contents of next wave queue 218.

Referring now to FIG. 3, an example of the availability map 214 and input intra-block queue 216 will now be described.

As shown at 300, an input intra-block list provides information about the blocks of an image that have been encoded using intra-prediction. By convention, each block is specified by a coordinate (x,y) corresponding to the top right pixel of the block. Thus, the information in the input intra-block list can be an identifier (e.g., “1” as indicated at 302), from which the coordinate can be derived, or can be the coordinates (e.g., “12, 4” as indicated at 304). Thus, block 1 is at location 12, 4; block 2 is at location 8, 8; block 3 is at location 12, 8 and block 4 is at location 20,16.

As in this example implementation, the availability map can be defined as an image data structure, in which each pixel of the image corresponds to a block in the input image. In FIG. 3, an availability map prior to initialization is illustrated at 320. Blocks 1, 2, 3 and 4 in the example intra-block list 300 are shown as shaded at their corresponding locations in the availability map illustrated at 320. Values that will be stored in the availability map for each intra-predicted block, at any given time after initialization, represent whether a. the pixel data of the neighboring blocks to be used as a reference for the intra-predicted block are available; b. whether the pixel data for the neighboring block will become available after a number of waves of processing have been completed; and c. whether the neighboring blocks are outside of the region (e.g., the or slice) of the intra-predicted block.

If the intra-prediction uses boundaries within the input frame, such as tiles or slices, to limit the extent of referencing by blocks within the input frame, each such region also can be associated with an identifier. For example, as shown in 320, the input frame is divided into two tiles 322 and 324. Each tile can be associated with an identifier or value, e.g., the left tile (322) can be called tile “0”; the right tile can be called tile “1”.

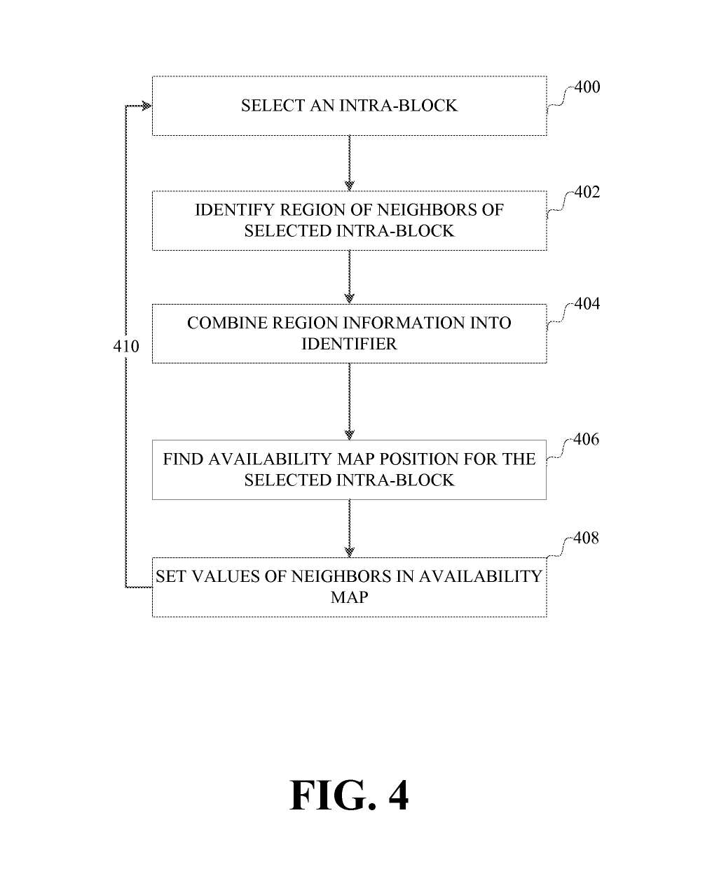

Referring now to FIG. 4, a flowchart of an example implementation for initializing the availability map will now be provided.

In the initialization process, each intra block to be processed in a frame is defined at location (x,y) and has size s (representing a number of pixels along an edge of the intra-block, e.g., 4). In this example implementation, the initialization process is a two-phase process which begins by the computer selecting (400) an intra-block, such as from list 300 in FIG. 3. Next, the computer identifies (402) the region (e.g., slice or tile) in which selected neighbors reside. In an HEVC implementation the following neighbors are checked: top-left (x−1,y−1), top (x,y−1), top-right (x+s,y−1), left (x−1,y), bottom-left (x−1,y+s). The region information, such as a segment and tile identifier for the neighboring block, is combined (404) into an integer identifier.

Next, the computer finds 406 an availability map position (bx, by) corresponding to coordinates (x,y) of an intra-block by using a mapping of intra-block coordinates to availability map positions. As an example, given intra-block coordinates x,y, a mapping of bx=x/s and by=y/s, where s is the size s of the intra-block in pixels as described above, can be used. Next, the computer sets 408 the values of the neighbors of the corresponding position in the availability map with an identifier. As an example, an integer identifier that can be used is: (bx−1,by−1), (bx,by−1), (bx+s/4,by−1), (bx−1,by), (bx−1,by+s/4).

In one implementation, the graphics processing unit maintains the availability map. In this implementation, the central processing unit can perform steps 400, 402 and 404 and then send the integer identifiers for each neighboring block to the GPU. The GPU then can perform steps 406 and 408 on the availability map. These steps are repeated for each block as indicated by arrow 410.

Thus, as shown at 330 in the example of FIG. 3, after this first stage of initialization, the neighbors of blocks 1, 2 and 3 have been processed and have been set with the value “0”, an integer identifier for the tile “0” in which they reside. Similarly, the neighbors of block 4 have been processed and some have been set with the value “1”, an integer identifier of the tile “1” in which those neighbors reside, whereas other neighbors have been set with the value “0”, because those neighbors reside in another tile.

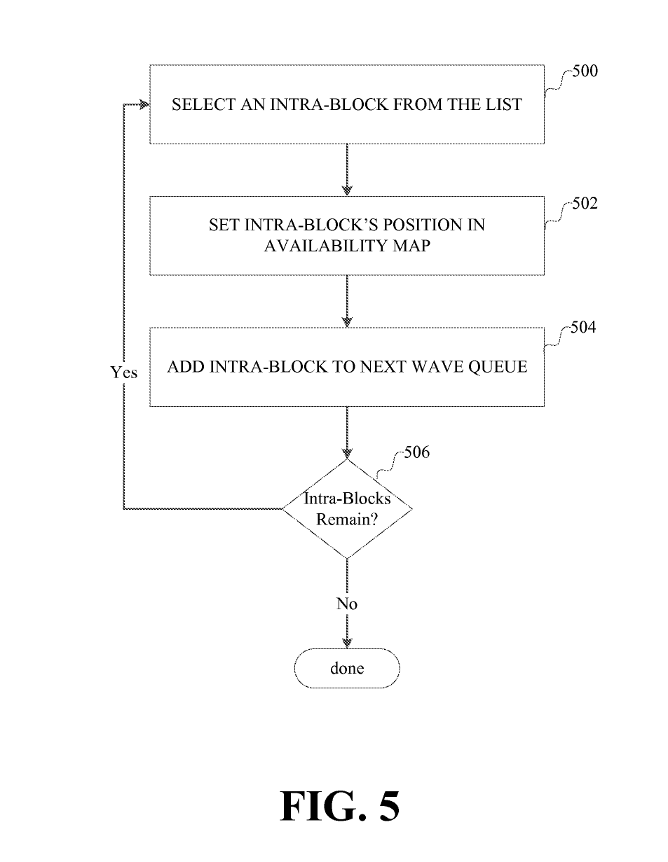

A second phase of initialization in this example implementation is shown in FIG. 5. In this implementation, this second phase is performed separately and after the first phase so that, if any neighbors of a block overlap with a block that needs processing, the neighbor information will be overwritten with information indicating the block needs processing. In this second phase, blocks are marked as requiring processing. At this initialization stage, the blocks requiring processing are the intra-blocks from the original input list, e.g., 300 in FIG. 3 or queue 216 in FIG. 2. The computer selects (500) an intra-block from the list 300. The computer sets (502) the position (bx,by) corresponding to the selected block in the availability map with a value indicating that the block needs processing. For example, reserved integer or value can be used for this purpose. The computer adds (504) this block to a list of blocks to be checked in a first wave of processing, such as queue 218 in FIG. 2. These steps repeat for all blocks in list 300 as indicated at 506.

Thus, as shown at 340 in the example of FIG. 3, after this second stage of initialization, each of the blocks 1, 2, 3 and 4 have been processed to have a value indicating that they need processing. At this stage, blocks 1, 2, 3 and 4 are in the queue 218a of blocks to be processed in the next wave.

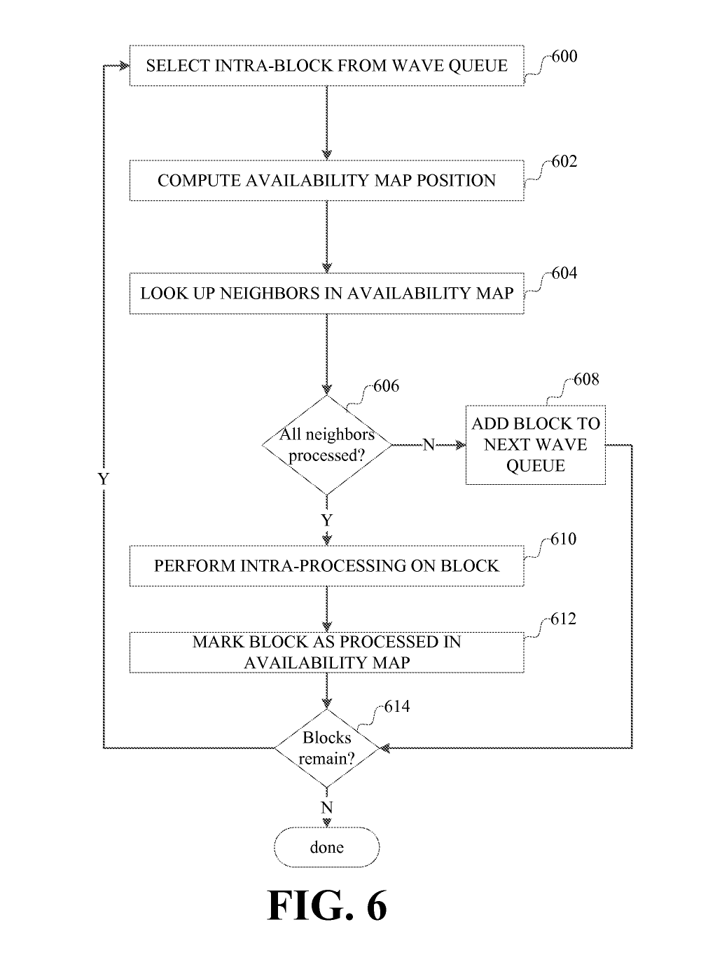

Given initialized data structures to be used for tracking dependencies of intra-blocks to be processed, wave processing of the intra-blocks can begin. An example implementation of such wave processing will now be described in connection with FIG. 6. Generally speaking, the blocks to be processed in each wave are those intra-blocks for which no neighbors are marked, at the beginning of the wave, as requiring processing. In each wave, these blocks are processed, and the dependency tracking information is updated, and blocks for the next wave are loaded in the queue.

Thus, the computer selects (600) the next block from the queue of blocks for the current wave of processing. In this example, each block has a location (x,y) and size s. The computer computes (602) the availability map position (bx,by) give the location (x,y) of the selected block, using the mapping of block coordinates to availability map coordinates (e.g., (x/4,y/4)). The computer looks up (604) all neighbors of the selected block in the availability map. If any neighbor is marked as requiring processing as determined at 606, the computer adds (608) the selected block to the list of blocks to be processed in the next wave (e.g., the selected block is added to a queue 218 in FIG. 2). Using the example of FIG. 3, intra-block 3, when processed in the first wave, has neighbors (intra-blocks 1 and 2) which require processing; therefore intra-block 3 is added to queue 218b. Thus, in response to a determination that a selected block has neighbors which require processing, the computer adds the selected block to a queue of blocks to be processed in a subsequent wave.

If all neighbors of the selected block are marked as either not requiring processing, or are not available, as determined in 606, the computer performs (610) intra-processing on this block. Thus, in response to a determination that a selected block does not have neighbors which require processing, the computer performs intra-processing on this block. Note, a block is not a dependency of the selected block if the block is outside the region containing the selected block. For example, blocks in the availability map marked “0” in tile “0” and adjacent to the block corresponding to intra-block “4”, which is in tile “1”, are not available. The computer then marks (612) this block in the availability map with the region identifier (e.g., an integer representing a slice or tile identifier) for the region containing this block. The process repeats for the next block in the queue of blocks to be processed, until all blocks are processed, as indicated at 614.

If the current wave of processing is completed, as determined at 614, and if the next wave queue is empty, then the computer can conclude that intra-processing for this image is complete. If the next wave queue is not empty, indicating intra-blocks remain to be processed, then the computer can initiate another wave of processing using the next wave queue. Thus, in response to a determination that intra-blocks remain to be processed after a wave of processing has completed, the computer initiates a next wave of processing. The computer iteratively performs waves of processing unit the queue of intra-blocks remaining to be processed for an image is empty.

Using the example of FIG. 3, intra-blocks 1, 2 and 4, when processed in the first wave, do not have any neighbors requiring processing. Thus, as a result of the first wave, these blocks are processed, whereas intra-block 3 is not processed and is added to the next wave queue 218b in FIG. 3. The availability map after this wave (350) still indicates this intra-block remains to be processed. Because intra-blocks 1, 2 and 4 are processed, their corresponding entries in the availability map are updated to indicate the pixel data for the corresponding intra-block are available. As a result of the second wave, which process intra-block 3, all intra-blocks are processed, there are no blocks marked as requiring processing in the availability map 360, and the next wave queue 218c is empty.

Using the foregoing example implementation, the graphics processing unit can be programmed to perform waves of parallel operations to decode intra-prediction blocks of an image. In particular, the currently decoded image data for the input frame is available to all shaders executed on the graphics processing. An instance of an intra-block processing shader can be dispatched for each intra-block identified for processing in parallel in a current wave. It should be understood that each intra-block to be processed may have each of its pixels processed in parallel.

However, the determination of which intra-blocks to process in a current wave can be implemented using an application on the central processing unit and/or on the graphics processing unit.

For example, the graphics processing unit can process each item in a list of intra-blocks in parallel, using the availability map, to determine the availability of blocks on which they have any dependencies. Thus, with dependency checking being performed on the graphics processing unit, a wave begins by the central processing unit instructing the GPU to process entries in a list of intra-blocks, i.e., the next wave queue, in parallel. This instruction results in intra-processing all blocks with data available and otherwise adding blocks to the next wave queue. When the wave is complete, the central processing unit instructs the GPU to perform the next wave of processing (if the next wave queue is non-empty).

As another example, the central processing unit can analyze dependencies of all intra-blocks in the next wave queue, for example by using an availability map. The CPU then generates a list of intra-blocks to be processed by the GPU in the next wave. Thus, in this implementation, the central processing unit instructs the GPU to process a set of intra-blocks selected by the central processing unit from the next wave queue.

The foregoing example implementations are intended to illustrate, not limit, techniques used to parallelize intra-processing operations on each input image using a graphics processing unit of a computer. In particular, waves of processing are performed, with each wave being defined by a set of intra-blocks for which image data from reference blocks is available. The intra-blocks in each wave are processed in parallel by the graphics processing unit. The determination of which intra-blocks have image data available from reference blocks can be determined by a central processing unit or by a graphics processing unit evaluating each intra-block in parallel. By parallelizing such operations, processing time for each image can be reduced.

Having now described an example implementation, FIG. 7 illustrates an example of a computing device in which such techniques can be implemented, whether implementing an encoder, decoder or preprocessor. This is only one example of a computer and is not intended to suggest any limitation as to the scope of use or functionality of such a computer.

The computer can be any of a variety of general purpose or special purpose computing hardware configurations. Some examples of types of computers that can be used include, but are not limited to, personal computers, game consoles, set top boxes, hand-held or laptop devices (for example, media players, notebook computers, tablet computers, cellular phones, personal data assistants, voice recorders), server computers, multiprocessor systems, microprocessor-based systems, programmable consumer electronics, networked personal computers, minicomputers, mainframe computers, and distributed computing environments that include any of the above types of computers or devices, and the like.

With reference to FIG. 7, an example computer 700 includes at least one processing unit 702 and memory 704. The computer can have multiple processing units 702. A processing unit 702 can include one or more processing cores (not shown) that operate independently of each other. Additional coprocessing units, such as graphics processing unit 720, also can be present in the computer. The memory 704 may be volatile (such as dynamic random access memory (DRAM) or other random access memory device), non-volatile (such as a read-only memory, flash memory, and the like) or some combination of the two. Memory can include dedicated registers or other storage in the processing unit or co-processing unit; this configuration of memory is illustrated in FIG. 7 by line 706. The computer 700 may include additional storage (removable and/or non-removable) including, but not limited to, magnetically-recorded or optically-recorded disks or tape. Such additional storage is illustrated in FIG. 7 by removable storage 708 and non-removable storage 710. The various components in FIG. 7 are generally interconnected by an interconnection mechanism, such as one or more buses 730.

A computer storage medium is any medium in which data can be stored in and retrieved from addressable physical storage locations by the computer. Computer storage media includes volatile and nonvolatile memory, and removable and non-removable storage media. Memory 704 and 706, removable storage 708 and non-removable storage 710 are all examples of computer storage media. Some examples of computer storage media are RAM, ROM, EEPROM, flash memory or other memory technology, CD-ROM, digital versatile disks (DVD) or other optically or magneto-optically recorded storage device, magnetic cassettes, magnetic tape, magnetic disk storage or other magnetic storage devices. The computer storage media can include combinations of multiple storage devices, such as a storage array, which can be managed by an operating system or file system to appear to the computer as one or more volumes of storage. Computer storage media and communication media are mutually exclusive categories of media.

Computer 700 may also include communications connection(s) 712 that allow the computer to communicate with other devices over a communication medium.

Communication media typically transmit computer program instructions, data structures, program modules or other data over a wired or wireless substance by propagating a modulated data signal such as a carrier wave or other transport mechanism over the substance. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, radio frequency, infrared and other wireless media. Communications connections 712 are devices, such as a wired network interface, wireless network interface, radio frequency transceiver, e.g., Wi-Fi, cellular, long term evolution (LTE) or Bluetooth, etc., transceivers, navigation transceivers, e.g., global positioning system (GPS) or Global Navigation Satellite System (GLONASS), etc., transceivers, that interface with the communication media to transmit data over and receive data from communication media, and may perform various functions with respect to that data.

Computer 700 may have various input device(s) 714 such as a keyboard, mouse, pen, camera, touch input device, sensor (e.g., accelerometer or gyroscope), and so on. Computer 700 may have various output device(s) 716 such as a display, speakers, a printer, and so on. All of these devices are well known in the art and need not be discussed at length here. The input and output devices can be part of a housing that contains the various components of the computer in FIG. 7, or can be separable from that housing and connected to the computer through various connection interfaces, such as a serial bus, wireless communication connection and the like. Various input and output devices can implement a natural user interface (NUI), which is any interface technology that enables a user to interact with a device in a “natural” manner, free from artificial constraints imposed by input devices such as mice, keyboards, remote controls, and the like.

Examples of NUI methods include those relying on speech recognition, touch and stylus recognition, hover, gesture recognition both on screen and adjacent to the screen, air gestures, head and eye tracking, voice and speech, vision, touch, gestures, and machine intelligence, and may include the use of touch sensitive displays, voice and speech recognition, intention and goal understanding, motion gesture detection using depth cameras (such as stereoscopic camera systems, infrared camera systems, and other camera systems and combinations of these), motion gesture detection using accelerometers or gyroscopes, facial recognition, three dimensional displays, head, eye, and gaze tracking, immersive augmented reality and virtual reality systems, all of which provide a more natural interface, as well as technologies for sensing brain activity using electric field sensing electrodes (such as electroencephalogram techniques and related methods).

The various storage 710, communication connections 712, output devices 716 and input devices 714 can be integrated within a housing with the rest of the computer, or can be connected through input/output interface devices on the computer, in which case the reference numbers 710, 712, 714 and 716 can indicate either the interface for connection to a device or the device itself as the case may be.

A computer generally includes an operating system, which is a computer program running on the computer that manages access to the various resources of the computer by applications. There may be multiple applications. The various resources include the memory, storage, communication devices input devices and output devices, such as display devices and input devices as shown in FIG. 7.

The operating system, file system and applications can be implemented using one or more processing units of one or more computers with one or more computer programs processed by the one or more processing units. A computer program includes computer-executable instructions and/or computer-interpreted instructions, such as program modules, which instructions are processed by one or more processing units in the computer. Generally, such instructions define routines, programs, objects, components, data structures, and so on, that, when processed by a processing unit, instruct the processing unit to perform operations on data or configure the processor or computer to implement various components or data structures.

In one aspect, a computer comprises a processing system, the processing system comprising a coprocessing unit and a central processing unit. The central processing unit is configured to instruct the coprocessing unit to perform intra-prediction operations on an encoded bitstream of image data comprising a plurality of blocks of an image. The blocks of the image include a plurality of intra-predicted blocks. The processing system is configured to determine, for each of the intra-predicted blocks remaining to be processed at a beginning of a wave of processing, dependency information indicating whether pixel data from a reference block for the intra-predicted block is available in memory. The coprocessing unit is configured to process the intra-predicted blocks remaining to be processed in the wave of processing according to the dependency information.

In one aspect, a computer comprising coprocessing unit and a central processing unit. The computer includes means for instructing the coprocessing unit to perform intra-prediction operations on an encoded bitstream of image data comprising a plurality of blocks of an image. The blocks of the image include a plurality of intra-predicted blocks. The computer includes means for determining, for each of the intra-predicted blocks remaining to be processed at a beginning of a wave of processing, dependency information indicating whether pixel data from a reference block for the intra-predicted block is available in memory. The coprocessing unit is configured to process the intra-predicted blocks remaining to be processed in the wave of processing according to the dependency information.

In another aspect, a process comprises determining, by a processing system comprising a graphics coprocessing unit and a central processing unit, for each of the intra-predicted blocks remaining to be processed at a beginning of a wave of processing, dependency information indicating whether pixel data from a reference block for the intra-predicted block is available in memory, and processing, by the graphics coprocessing unit, the intra-predicted blocks remaining to be processed in the wave of processing according to the dependency information.

In another aspect, an article of manufacture comprises a computer storage medium and computer program instructions stored on the computer storage medium which, when processed by a processing system of a computer comprising a coprocessing unit and a central processing unit, configure the central processing unit to instruct the coprocessing unit to perform intra-prediction operations on an encoded bitstream of image data comprising a plurality of intra-predicted blocks of an image, and configure the processing system to determine, for each of the intra-predicted blocks remaining to be processed at a beginning of a wave of processing, dependency information indicating whether pixel data from a reference block for the intra-predicted block is available in memory, and configure the coprocessing unit to process the intra-predicted blocks remaining to be processed in the wave of processing according to the dependency information.

In any of the foregoing aspects, coprocessing unit can be configured to determine the dependency information for each of the intra-predicted blocks remaining to be processed.

In any of the foregoing aspects, the central processing unit can be configured to determine the dependency information for each of the intra-predicted blocks remaining to be processed.

In any of the foregoing aspects, the dependency information can comprise an availability map indicating, for each block to be used in intra-prediction, availability of pixel data for the block in memory.

In any of the foregoing aspects, the coprocessing unit can be further configured, for each intra-block remaining to be processed in a wave, to generate pixel data for the intra-predicted block in response to a determination that the pixel data from a reference block is available.

In any of the foregoing aspects, for each wave of processing, the processing system can be further configured to access a queue of intra-blocks to be processed in the wave.

In any of the foregoing aspects, in a wave of processing the processing system can be further configured to add an intra-block to a queue for a next wave in response to a determination that pixel data from a reference block is not yet available.

In any of the foregoing aspects, the processing system can be configured to iteratively process intra-blocks in waves until the queue for any next wave is empty after completion of processing a wave.

In any of the foregoing aspects, the central processing unit can be further configured, for each intra-block remaining to be processed, to instruct the coprocessing unit to generate pixel data for the intra-predicted block in response to a determination that the pixel data from a reference block is available.

In any of the foregoing aspects, the coprocessing unit can be a graphics processing unit, or a digital signal processor, or a programmable gate array, or a dedicated processing logic device.

Any of the foregoing aspects may be embodied in one or more computers, as any individual component of such a computer, as a process performed by one or more computers or any individual component of such a computer, or as an article of manufacture including computer storage with computer program instructions are stored and which, when processed by one or more computers, configure the one or more computers.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer comprising a processing system, the processing system comprising:
a coprocessing unit; and
a central processing unit configured to instruct the coprocessing unit to perform intra-prediction operations on an encoded bitstream of image data comprising a plurality of blocks of an image, the blocks of the image including a plurality of intra-predicted blocks,
the processing system configured to determine, for each of the intra-predicted blocks remaining to be processed at a beginning of a wave of processing, dependency information indicating whether pixel data from a reference block for the intra-predicted block is available in memory, and
the coprocessing unit configured to process the intra-predicted blocks remaining to be processed in the wave of processing according to the dependency information.

2. The computer of claim 1, wherein the coprocessing unit comprises a graphics processing unit.

3. The computer of claim 2, wherein the graphics processing unit is configured to determine the dependency information for each of the intra-predicted blocks remaining to be processed.

4. The computer of claim 2, wherein the central processing unit is configured to determine the dependency information for each of the intra-predicted blocks remaining to be processed.

5. The computer of claim 2, wherein, for each wave of processing, the processing system is further configured to access a queue of intra-blocks to be processed in the wave.

6. The computer of claim 2, wherein the dependency information comprises an availability map indicating, for each block to be used in intra-prediction, availability of pixel data for the block in memory.

7. The computer of claim 3, wherein the graphics processing unit is further configured, for each intra-block remaining to be processed in a wave, to generate pixel data for the intra-predicted block in response to a determination that the pixel data from a reference block is available, and to add the intra-block to a queue for a next wave in response to a determination that the pixel data from a reference block is not yet available.

8. The computer of claim 7, wherein processing system is configured to iteratively process intra-blocks in waves until the queue for any next wave is empty after completion of processing a wave.

9. The computer of claim 3, wherein the central processing unit is further configured, for each intra-block remaining to be processed, to instruct the graphics processing unit to generate pixel data for the intra-predicted block in response to a determination that the pixel data from a reference block is available.

10. A computer-implemented process to perform intra-prediction operations on an encoded bitstream of image data comprising a plurality of blocks of an image, the blocks of the image including a plurality of intra-predicted blocks, the process comprising:
determining, by a processing system comprising a coprocessing unit and a central processing unit, for each of the intra-predicted blocks remaining to be processed at a beginning of a wave of processing, dependency information indicating whether pixel data from a reference block for the intra-predicted block is available in memory; and
processing, by the coprocessing unit, the intra-predicted blocks remaining to be processed in the wave of processing according to the dependency information.

11. The computer-implemented process of claim 10, wherein the coprocessing unit comprises a graphics processing unit.

12. The computer-implemented process of claim 11, wherein determining dependency information comprises determining, by the graphics processing unit, the dependency information.

13. The computer-implemented process of claim 12, further comprising:
for each intra-block remaining to be processed, generating, using the graphics processing unit, pixel data for the intra-predicted block in response to a determination that the pixel data from a reference block is available, and
adding, by the graphics processing unit, the intra-block to a queue for a next wave in response to a determination that the pixel data from a reference block in not yet available.

14. The computer-implemented process of claim 11, wherein determining dependency information comprises determining, by the central processing unit, the dependency information.

15. The computer-implemented process of claim 14, further comprising, for each intra-block remaining to be processed, instructing, by the central processing unit, the graphics processing unit to generate pixel data for the intra-predicted block in response to a determination that the pixel data from a reference block is available.

16. The computer-implemented process of claim 10, wherein determining dependency information comprises accessing a queue of intra-blocks to be processed in the wave.

17. The computer-implemented process of claim 10, wherein the dependency information comprises an availability map indicating, for each block to be used in intra-prediction, availability of pixel data for the block in memory.

18. An article of manufacture comprising:
a computer storage medium;
computer program instructions stored on the computer storage medium which, when processed by a processing system of a computer comprising a graphics processing unit and a central processing unit, configure the central processing unit to instruct the coprocessing unit to perform intra-prediction operations on an encoded bitstream of image data comprising a plurality of blocks of an image, the blocks of the image including a plurality of intra-predicted blocks and configure the processing system to determine, for each of the intra-predicted blocks remaining to be processed at a beginning of a wave of processing, dependency information indicating whether pixel data from a reference block for the intra-predicted block is available in memory, and configure the coprocessing unit to process the intra-predicted blocks remaining to be processed in the wave of processing according to the dependency information.

19. The article of manufacture of claim 18, wherein the coprocessing unit is configured to determine the dependency information for each of the intra-predicted blocks remaining to be processed.

20. The article of manufacture of claim 18, wherein the central processing unit is configured to determine the dependency information for each of the intra-predicted blocks remaining to be processed.
